(19) United States
(12) Patent Application Publication
(10) Pub. No.: US 2009/0157624 A1
(43) Pub. Date: Jun. 18, 2009

(54) SYSTEM AND METHOD FOR INDEXING HIGH-DIMENSIONAL DATA IN CLUSTER SYSTEM

(75) Inventors: Kyu-Woong LEE, Kangwon-do (KR); Mi-Young Lee, Daejeon (KR); Hun-Soon Lee, Daejeon (KR); Myung-Joon Kim, Deajeon (KR)

Correspondence Address: STAAS & HALSEY LLP, SUITE 700, 1201 NEW YORK AVENUE, N.W., WASHINGTON, DC, 20005, US

(73) Assignee: ELECTRONIC AND TELECOMMUNICATIONS RESEARCH INSTITUTE, Daejeon (KR)

(21) Appl. No.: 12/207,180

(22) Filed: Sep. 9, 2008

(30) Foreign Application Priority Data
Dec. 17, 2007 (KR) 10-2007-132589

(51) Int. Cl. G06F 17/30; G06F 7/06

(52) U.S. Cl. 707/3; 707/102; 707/E17.057; 707/E17.014

(57) ABSTRACT

Provided are a system and a method for indexing high-dimensional data in parallel in a cluster environment. The system for indexing high-dimensional data in parallel in a cluster environment includes a Spill-tree creation means for creating a Spill-tree using an sampled N-dimensional feature vector, a feature vector division storage means for distributedly storing the N-dimensional feature vector in a terminal node of the Spill-tree, and a local signature creation means for creating and managing a local signature for the N-dimensional feature vector dispersed into each node of the Spill-tree.

### CROSS-REFERENCE TO RELATED APPLICATIONS

This application claims priority under 35 U.S.C. §119 to Korean Patent Application No. P2007-132589, filed on Dec. 12, 2007, the disclosure of which is incorporated herein by reference in its entirety.

### BACKGROUND OF THE INVENTION

1. Field of the Invention

The present disclosure relates to a system and a method for indexing high-dimensional data in a cluster environment, and more particularly, to a system and a method for indexing high-dimensional data in a cluster environment, which can provide high performance and high scalability by doing a search at each node in parallel by using a signature after filtering with a Spill-tree.

This work was supported by the IT R&D program of MIC/IITA. [2007-S-016-01, A Development of Cost Effective and Large Scale Global Internet Service Solution]

2. Description of the Related Art

Developments of computing and media technologies enable information to be expressed in the form of multimedia including texts, images, audios, and videos. Particularly, as the advent of Web 2.0 shifts Internet service from a provider-based paradigm to one that is user-based, the amount and use of multimedia data such as user created contents (UCC) are on the rapid increase in Internet services.

A major problem in handling multimedia information is retrieval efficiency. This problem is how quickly and exactly a user can search data containing desired information. Generally, high-dimensional feature vector data extracted from multimedia objects such as images, audios, and videos is used for retrieval. This type of search is called a content-based retrieval. It is important to index high-dimensional data for more rapid and exact content-based retrieval of multimedia objects.

A tree-based indexing scheme and a filtering-based scheme have been proposed in the field of research on the content-based retrieval of the high-dimensional data.

The tree-based indexing scheme uses a rectangle or a circle representing a group of adjacent objects as a search unit for efficient search of the objects dispersed in a data space. However, an increase of data dimension enlarges an overlapping region between the rectangles and the circles and thus causes exponential degradation of the search performance. This problem is called “the curse of dimension” causing a lower search performance than a sequential search.

The filtering-based scheme improves the search performance for high-dimensional data by using a signature. In the filtering-based scheme, the feature vectors are read after all the signature files are sequentially read for a primary filtering. Accordingly, there is a problem in that search accuracy is decreased if bit size for signature become smaller and the amount of data to be read is increased if bit size for signature become larger. Therefore, it is difficult for a single computing node to index high-dimensional data for billions of multimedia objects.

The tree-based indexing scheme provides the scalability for large volume data since data are distributedly stored at different computing nodes for each subtree. However, the tree-based indexing scheme cannot avoid performing the backtracking in order to get the k nearest neighbor even though extended to a cluster environment basis, and, in the worst case, cannot help having a similar performance with the search performance in a single computing node.

The signature-based scheme has a disadvantage that entire signature file must be sequentially scanned to support content-based retrieval. Even though signature files are distributedly stored, we should scan all the fraction of signature file which are stored at each node. Accordingly, the signature-based scheme cannot take the advantage of the cluster computer environment, resulting in a low search performance.

### SUMMARY

Therefore, an object of the present invention is to provide a high dimensional data indexing system of supporting a high scalability for a large amount of data by using a method merging a Spill-tree scheme and a signature search scheme in performing a content-based retrieval for multimedia objects using a high dimensional feature vector data in a cluster computing environment, and a method of the same.

To achieve these and other advantages and in accordance with the purpose(s) of the present invention as embodied and broadly described herein, a system for indexing high-dimensional data in parallel in a cluster environment in accordance with an aspect of the present invention includes: a Spill-tree creator for creating a Spill-tree based on an sampled N-dimensional feature vector; storage for distributedly storing the N-dimensional feature vector in a terminal node of the Spill-tree; and local signature creator for creating and managing a signature for the N-dimensional feature vector dispersed into each node of the Spill-tree.

To achieve these and other advantages and in accordance with the purpose(s) of the present invention, a method for indexing high-dimensional data in parallel in a cluster environment in accordance with another aspect of the present invention includes: creating a Spill-tree by extracting random samples from a group of N-dimensional feature vectors; storing the feature vector at the node by determining a computing node in which the feature vectors are distributedly stored in accordance with a configuration of the Spill-tree; and generating and storing a signature with respect to the feature vector distributedly stored at each node.

To achieve these and other advantages and in accordance with the purpose(s) of the present invention, a method for searching high-dimensional data in parallel in a cluster environment in accordance with another aspect of the present invention includes: executing a Spill-tree search using a value of a query feature vector; determining a candidate node from one or more terminal nodes having a similar value to the value of the query feature vector in the Spill-tree as the result of the above search; performing an operation on a signature of the query feature vector at the candidate node; and searching a local signature file using the signature of the query feature vector.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a block diagram illustrating a parallel indexing system for high dimensional data in a cluster computing environment according to an embodiment of the present invention;

FIG. 2 is a diagram illustrating a scheme for converting an N-dimensional vector into a signature according to an embodiment of the present invention;

FIG. 3 is a diagram illustrating a scheme for structuring a complex Spill-tree by using the N-dimensional vector according to an embodiment of the present invention;

FIG. 4 is a flowchart illustrating a method for indexing high-dimensional data in parallel in a cluster system according to an embodiment of the present invention;

FIG. 5 is a flowchart illustrating a method for searching high-dimensional data in parallel in a cluster system according to an embodiment of the present invention; and

FIG. 6 is a flowchart illustrating a method for adding a feature vector and a signature in accordance with an addition of a multimedia object.

### DETAILED DESCRIPTION OF EMBODIMENTS

Typical indexing schemes supporting a high dimensional data search store all data in one computing node, but the typical indexing schemes do not take a parallel process into consideration. Accordingly, the response time of the search may be inefficient due to an increase of the amount of data.

According to an embodiment of the present invention, a search efficiency of a high dimensional data can be maximized due to the following characteristics: a high dimensional data space is expressed in Spill-tree by using a sampled feature vector; a signature of a feature vector is stored in the terminal node of the Spill-tree; and information for routing (i.e., the Spill-tree) and real data (i.e., the terminal node) are stored in the other node. Accordingly, the high dimensional data have a structure that may perform the parallel search of the terminal node.

Hereinafter, a preferable embodiment according to the present invention will be described in detail with reference to the accompanying drawings.

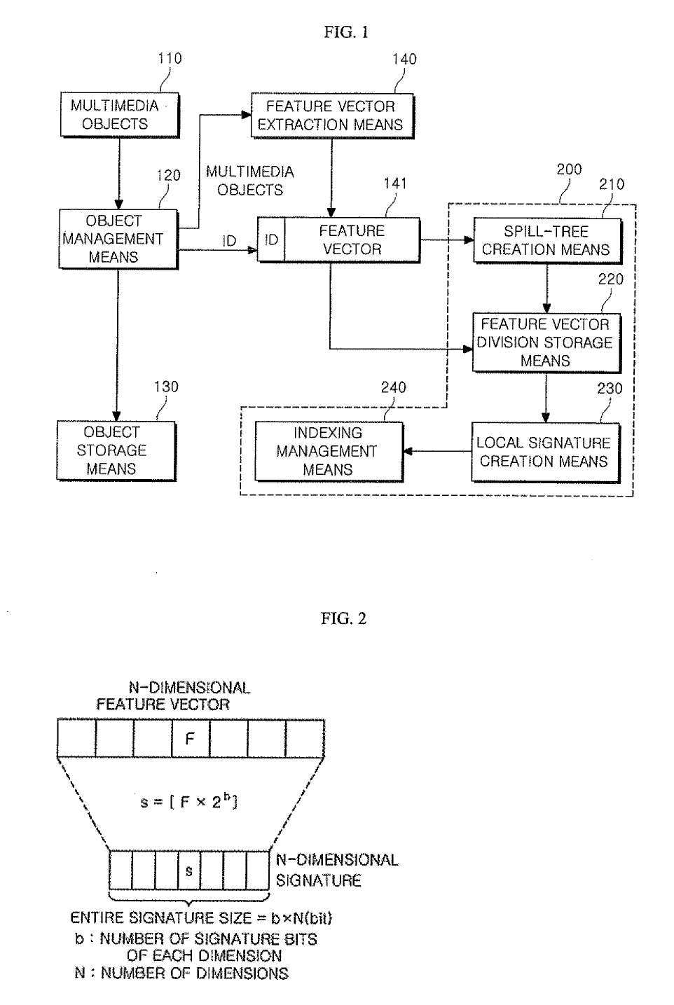

FIG. 1 is a block diagram illustrating a parallel indexing system for high dimensional data in a cluster computing environment according to an embodiment of the present invention.

Referring to FIG. 1, a parallel indexing system for high dimensional data includes a cluster-based high dimensional indexing unit 200, an object management means 120, an object storage means 130, and a feature vector extraction means 140.

The object management means 120 allocates multimedia objects 110 such as videos or images to a specific computing node and manages them. The object management means 120 receives multimedia objects 110 and creates the object identifier ID to each of the received multimedia objects 110. Also, the object management means 120 sends the multimedia objects to the object storage means 130.

The object storage means 130 receives the multimedia objects from the object management means 120 and stores them.

The feature vector extraction means 140 extracts an N-dimensional feature vector from the multimedia objects 110 according to the control of the object management means 120. The N-dimensional feature vector is linked with the object identifier ID by the object management means 120 and/or the feature vector extraction means 140.

The cluster-based high dimensional indexing unit 200 includes a Spill-tree creation means 210, an N-dimensional feature vector divisional storage means 220, a signature creation means 230, and a distributed high dimensional indexing management means 240. The Spill-tree creation means 210 constructs a Spill-tree using random samples extracted from a given N-dimensional feature vectors 141. The N-dimensional feature vector divisional storage means 220 distributedly stores a large amount of the given N-dimensional feature vectors according to a definition of terminal node range of the constructed Spill-tree. The local signature creation means 230 generates and manages the local signatures for the N-dimensional feature vectors distributed into each computing node. The distributed high dimensional indexing management means 240 manages the generated complex Spill-tree and supports search requests from users. Preferably, the number of the random samples is as large as can be accommodated on single computing node.

FIG. 2 is a diagram illustrating a scheme for converting an N-dimensional feature vector into an signature according to an embodiment of the present invention. A data space is divided into a cell in a cell-based filtering. Each cell is converted into a signature. The signature is obtained by representing the cell as a 1 and 0 bit pattern. A vector which represents an object on a high dimensional space is stored after being converted into the signature of the cell including the object.

Referring to FIG. 2, each of the N-dimensional feature vectors is converted into a signature with b bit for each dimension by using the following equation (1)

Sᵢ=[Fᵢ·2^{b}] (1)

where Fᵢ is an i-th dimensional feature vector, Sᵢ is a signature for the i-th dimensional feature vector, b is the number of a signature bit allocated to each dimensional feature vector, and [ ] means round-down of the decimal places.

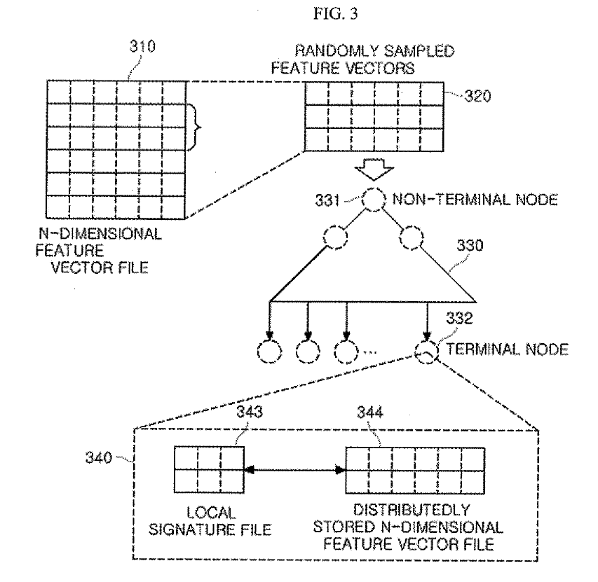

FIG. 3 is a diagram illustrating a scheme for constructing a complex Spill-tee by using the N-dimensional vector according to an embodiment of the present invention.

Referring to FIG. 3, a feature vector sample 320 is constituted by feature vectors which are randomly-sampled from the entire group of N-dimensional feature vectors 310. The number of the sampled feature vectors is as large as can be accommodated on single node in a cluster computing environment. A complex Spill-tree 330 is created for the feature vector samples 320.

Especially, the feature vector samples 320 constitutes a non-terminal node 331 of the complex Spill-tree, and serves as a routing node determining whether to search the complex Spill-tree. Furthermore, the N-dimensional feature vectors corresponding to a range defined by the terminal nodes in the complex Spill-tree is distributedly stored at each node. A local signature file 343 for the divided feature vectors 344 is independently created for each node.

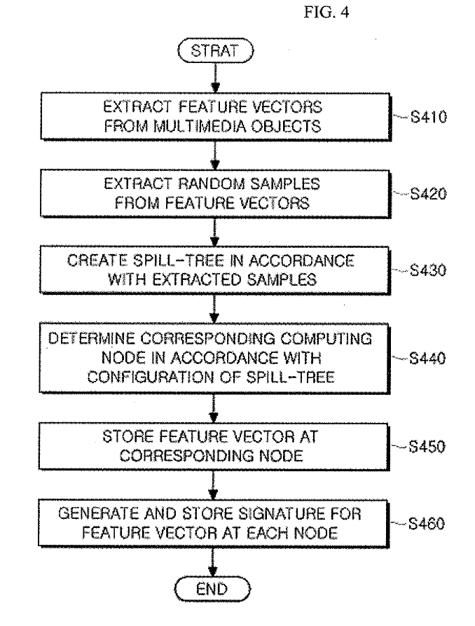

FIG. 4 is a flowchart illustrating a method for indexing high-dimensional data in parallel in a cluster system according to an embodiment of the present invention.

Referring to FIG. 4, in operation S410, an N-dimensional feature vector is extracted from a multimedia object through a feature vector extractor. In operation S420, a part of the N-dimensional feature vectors is randomly sampled from the entire group of the extracted N-dimensional feature vectors. Herein, the number of the random samples is smaller than the number that can be accommodated on single node in the cluster computing environment.

In operation S430, a Spill-tree is created for the sampled feature vectors. In operation S440, nodes in which the feature vectors are stored are determined in accordance with the created Spill-tree.

In operation S450, the feature vectors are distributedly and locally stored in each of the computing nodes in accordance with the operation S450. In operation S460, a local signature file is parallelly created for the feature vector that is distributedly stored in each computing node.

According to the embodiment of the present invention, a sequential search for entire signature files can be converted into a search for signature file corresponding to a fraction of feature vector, thereby solving a most important problem in the high dimensional indexing search.

Furthermore, since a parallel process capable of partial search at each node is possible, an efficient high dimensional data search can be performed.

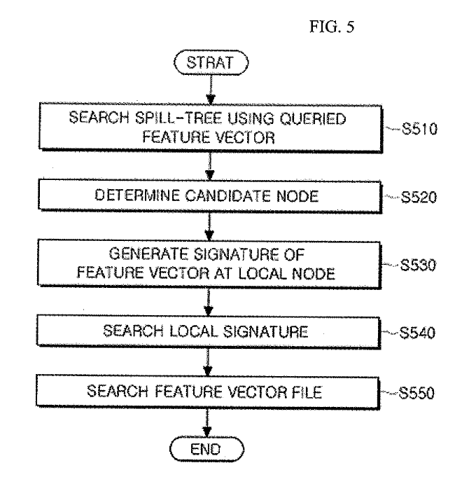

FIG. 5 is a flowchart illustrating a method for searching high-dimensional data in parallel in a cluster system according to an embodiment of the present invention.

Referring to FIG. 5, in operation S510, a Spill-tree is searched according to queried feature vector. In operation S520, a corresponding computing node (candidate node) having a similar value with the queried feature vector to be searched is determined on the basis of the search result of the Spill-tree. In this operation, one or more node may be the candidate node in accordance with a range of terminal nodes of the Spill-tree.

In operation S530, a signature for the queried feature vector is generated at the corresponding nodes. In operation S540, a local signature file is searched on the basis of the created signature corresponding to the queried feature vector.

In operation S550, an actual feature vector value is searched and returned together with the results after the signature is searched at one or more nodes through the above operation.

Search method according to the embodiment of the present invention, desired search results can be obtained without searching a large amount of a feature vector group or a signature group, thereby providing a more efficient search performance than a typical high dimensional indexing scheme.

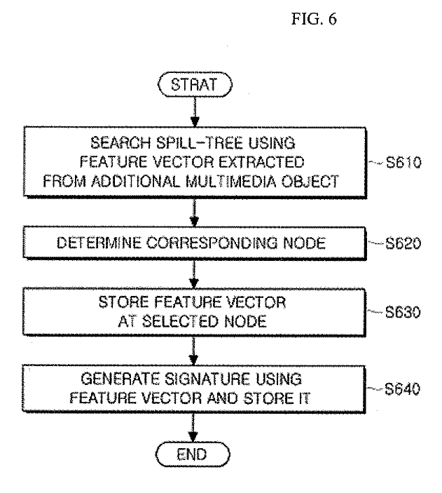

FIG. 6 is a flowchart illustrating a method of creating a feature vector and a signature in accordance with an addition of multimedia object.

In operation S610, a Spill-tree for N-dimensional feature vectors extracted from an additional multimedia object is searched.

In operation S620, a node corresponding to the given N-dimensional feature vector is determined in the Spill-tree. In operation S630, if the corresponding node is determined, the given N-dimensional feature vector is transmitted to the corresponding node to be distributedly stored in it. A local signature is recreated from the stored feature vector, and is stored.

According to the present invention, high performance as well as high scalability for a large amount of data can be supported by primarily performing a content-based search for high dimensional data using a Spill-tree and performing a parallel search using a signature at a corresponding node.

As the present invention may be embodied in several forms without departing from the spirit or essential feature thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A system for indexing high-dimensional data in parallel in a cluster environment, the system comprising:
a Spill-tree creator for creating a Spill-tree using a sampled N-dimensional feature vector;
a feature vector division storage for distributedly storing the N-dimensional feature vector in a terminal node of the Spill-tree; and
a local signature creator for creating and managing a local signature for the N-dimensional feature vector dispersed into each node of the Spill-tree.

2. The system of claim 1, further comprising an indexing manager for performing a search requested from a user.

3. The system of claim 1, the Spill-tree creator extracts a feature vector sample by randomly sampling the N-dimensional feature vectors, and constructs a complex Spill-tree, non-terminal node of which is the sampled N-dimensional feature vector.

4. The system of claim 1, further comprising:
an object manager for allocating a multimedia object to a specific computing node and managing the specific computing node, and creating the object identifier to the multimedia object; and
a feature vector extractor for extracting the N-dimensional feature vector from the multimedia object.

5. The system of claim 4, wherein the N-dimensional feature vector is linked with the object identifier.

6. A method for indexing high-dimensional data in parallel in a cluster environment, the method comprising:
creating a Spill-tree by extracting random samples from a group of N-dimensional feature vectors;
determining one or more computing nodes in which the N-dimensional feature vectors are distributedly stored in accordance with a configuration of the Spill-tree and storing the N-dimensional feature vectors at the each computing node;
creating and storing a local signature with respect to the N-dimensional feature vectors distributedly stored at the each computing node.

7. The method of claim 6, wherein the creating of the Spill-tree comprises extracting the N-dimensional feature vector from a multimedia object and creating the group of the N-dimensional feature vector.

8. The method of claim 6, further comprising creating the N-dimensional feature vector and a signature in accordance with an additional multimedia object.

9. The method of claim 8, wherein the creating of the feature vector and the signature comprises:
searching the Spill-tree with the N-dimensional feature vector and determining a corresponding node;
storing the feature vector at the corresponding node; and
recreating and storing a local signature with respect to the feature vector at the corresponding node.

10. A method for searching high-dimensional data in parallel in a cluster environment, the method comprising:
executing a Spill-tree search on the basis of a value of a query feature vector;
determining a candidate node from one or more terminal nodes having a similar value to the value of the query feature vector in the Spill-tree as the result of the above search;
generating a signature of query feature vector at the candidate node; and
searching a local signature file on the basis of the generated signature of the query feature vector.

11. The method of claim 10, further comprising:
performing a local signature search at the candidate node; and
searching a value of a feature vector corresponding to the searched signature.
